(19) United States
(12) Patent Application Publication
(10) Pub. No.: US 2017/0357123 A1
(43) Pub. Date: Dec. 14, 2017

(54) LIQUID CRYSTAL DISPLAY MODULE AND METHOD FOR FABRICATING THE SAME, DISPLAY DEVICE

(71) Applicants: BOE TECHNOLOGY GROUP CO., LTD., Beijing (CN); BOE (HEBEI) MOBILE DISPLAY TECHNOLOGY CO., LTD., Hebei (CN)

(72) Inventors: Dahua ZHU, Beijing (CN); Tao WANG, Beijing (CN); Xuefeng LI, Beijing (CN)

(73) Assignees: Boe Technology Group Co., Ltd., Beijing (CN); Boe (Hebei) Mobile Display Technology Co., Ltd., Hebei (CN)

(21) Appl. No.: 15/540,335

(22) PCT Filed: Dec. 11, 2015
(86) PCT No.: PCT/CN2015/097122

§ 371 Date: Jun. 28, 2017

(30) Foreign Application Priority Data
Jul. 30, 2015 (CN) 201510457212.7

(51) Int. Cl. G02F 1/1333; G02F 1/1335

(52) U.S. Cl. CPC G02F 1/133308; G02F 1/133528; G02F 1/133512; G02F 1/133602; G02F 2001/133314

(57) ABSTRACT

A liquid crystal display module, a method for fabricating the same, and a display device are disclosed. The liquid crystal display module includes a liquid crystal display panel and a backlight module. The liquid crystal display panel and the backlight module are fixed by an adhesive which is applied on an outer surface of at least a side. The disclosure provides for firmly adhering the liquid crystal display panel and the backlight module. By controlling the thickness of adhesive, it is possible to decrease the bezel width of the liquid crystal display module.

### RELATED APPLICATIONS

The present application is the U.S. national phase entry of PCT/CN2015/097122, with an international filing date of Dec. 11, 2015, which claims the benefit of Chinese Patent Application 201510457212.7, filed on Jul. 30, 2015, the entire disclosures of which are incorporated herein by reference.

### TECHNICAL FIELD

The present disclosure relates to the field of display technology, and particularly to a liquid crystal display module (LCM), a method for fabricating the same, and a display device.

### BACKGROUND

As shown in FIG. 1a, a liquid crystal display module 10′ generally comprises a liquid crystal display panel 100′ and a backlight module 200′. The liquid crystal display panel 100′ comprises an array substrate 110′, a color film substrate 120′, and liquid crystal 130′ sandwiched between the array substrate 110′ and the color film substrate 120′. The backlight module 200′ comprises a light source, a light guide plate, optical films, or the like (not shown). The liquid crystal display panel 100′ and the backlight module 200′ are adhered by means of a double-side adhesive tape 400′ to form the liquid crystal display module 10′. Generally, the double-side adhesive tape 400′ is arranged at four sides of the liquid crystal display module.

As shown in the enlarged view in FIG. 1b, the double-side adhesive tape 400′ generally has a width W′, to provide the required the strength of adhesion for fixing the liquid crystal display panel 100′ and the backlight module 200′. Due to the restriction during a cutting process, the width W′ of the double-side adhesive tape 400′ generally has a minimum value of 0.8 mm. Besides, the width W′ of the double-side adhesive tape 400′ generally should not be smaller than 0.8 mm to provide the required the strength of adhesion. Therefore, due to restriction of the width W′ of the double-side adhesive tape 400′, the liquid crystal display module 10′ has a bezel width which is hardly smaller than 0.8 mm.

Therefore, there is a need in the art for an improved liquid crystal display module.

### SUMMARY

Embodiments of the present disclosure provide a liquid crystal display module, a method for fabricating the same, and display device, which alleviate or eliminate one or more of the above problems. In particular, embodiments of the present disclosure provide a solution for replacing the double-side adhesive tape which realizes firm adhesion between panels of the liquid crystal display module, and decreases the width of a narrow bezel of the liquid crystal display module.

In a first aspect, an exemplary embodiment of the present disclosure provides a liquid crystal display module, comprising a liquid crystal display panel and a backlight module, wherein the liquid crystal display panel and the backlight module are fixed by an adhesive which is applied on an outer surface of at least a side.

According to certain exemplary embodiments of the present disclosure, in the liquid crystal display module, an adhesive is applied on an outer surface of at least a side of the liquid crystal display panel and the backlight module, for realizing firm adhesion therebetween. Since the adhesive is applied on the outer surface of the side to fix the liquid crystal display panel and the backlight module, the double-side adhesive tape is no longer required for adhesion. Namely, exemplary embodiments of the present disclosure provide a solution for replacing the double-side adhesive tape, and the solution realizes firm adhesion between the liquid crystal display panel and the backlight module. In addition, according to exemplary embodiments of the present disclosure, since the double-side adhesive tape is not used, the bezel width of the liquid crystal display module is not restricted by the width of the double-side adhesive tape, and by controlling the thickness of adhesive, it is possible to decrease the bezel width of the liquid crystal display module.

In an exemplary embodiment, the adhesive is applied on the outer surface of four sides of the liquid crystal display panel and the backlight module.

According to certain exemplary embodiments of the present disclosure, the adhesive is applied on four sides, i.e., all sides of the liquid crystal display panel and the backlight module in the liquid crystal display module. This realizes firm adhesion between the liquid crystal display panel and the backlight module. Besides, by controlling the thickness of adhesive, it is possible to decrease the bezel width of the liquid crystal display module at four sides.

In an exemplary embodiment, the adhesive is applied on the outer surface of one side, two sides, or three sides of the liquid crystal display panel and the backlight module.

According to certain exemplary embodiments of the present disclosure, the adhesive is applied on the corresponding side(s) of the liquid crystal display panel and the backlight module in view of design requirements, to realize firm adhesion between the liquid crystal display panel and the backlight module. Besides, by controlling the thickness of adhesive, it is possible to decrease the bezel width of the liquid crystal display module at a corresponding side(s).

In an exemplary embodiment, at a side of the liquid crystal display panel and the backlight module on which the adhesive is not applied, the double-side adhesive tape is applied between the liquid crystal display panel and the backlight module.

According to certain exemplary embodiments of the present disclosure, the double-side adhesive tape in the existing process can be used and applied at a side of the liquid crystal display panel and the backlight module on which the adhesive is not applied. Namely, the use of the double-side adhesive tape is not excluded in exemplary embodiments of the present disclosure. According to certain exemplary embodiments of the present disclosure, the adhesive and the double-side adhesive tape are combined, which further increases the strength of adhesion between the liquid crystal display panel and the backlight module.

In an exemplary embodiment, the liquid crystal display panel comprises an array substrate and a color film substrate, and the liquid crystal display panel is fixed to the backlight module through the array substrate; and at a side of the array substrate of the liquid crystal display panel which extends beyond the color film substrate, the double-side adhesive tape is applied between the array substrate and the backlight module.

According to certain exemplary embodiments of the present disclosure, the double-side adhesive tape is applied between the array substrate and the backlight module, at a side of the array substrate which extends beyond the color film substrate. In the liquid crystal display module, the array substrate may extend beyond the color film substrate at one or more sides. Namely, in a direction perpendicular to the one or more sides, the array substrate has a width larger than a width of the color film substrate. At the one or more sides, a peripheral region of the array substrate which is wider than the color film substrate acts as, e.g., a flexible printed circuit board (FPC) connection region or a driver IC bonding region. Thus, the bezel width of the liquid crystal display module at the one or more sides is generally not sensitive to whether the double-side adhesive tape is used as well as the width of the double-side adhesive tape. In view of this, for example, at the one or more sides, the double-side adhesive tape is applied between the array substrate and the backlight module to further increase the strength of adhesion.

In an exemplary embodiment, the adhesive is a UV curable adhesive, a thermosetting adhesive, or a thermoplastic adhesive.

According to certain exemplary embodiments of the present disclosure, the UV curable adhesive, the thermosetting adhesive, or the thermoplastic adhesive is applicable to fix the liquid crystal display panel and the backlight module. Namely, there is no special restriction for the adhesive in the present disclosure. This reduces the production cost of liquid crystal display module.

In an exemplary embodiment, the adhesive is black in color.

According to certain exemplary embodiments of the present disclosure, the color of the adhesive is selected in view of design requirements. In case the black adhesive is applied to fix the liquid crystal display panel and the backlight module, the black adhesive prevents the light leakage in the liquid crystal display module due to its opaque nature. The adhesive may have other dark colors.

In an exemplary embodiment, the adhesive has a thickness of 0.05-0.5 mm.

According to certain exemplary embodiments of the present disclosure, the adhesive generally has a thickness of 0.05-0.5 mm, and the thickness of adhesive may be selected in view of design requirements. Due to the limit of apparatus accuracy, it is generally difficult to realize an adhesive thickness smaller than 0.05 mm. In contrast, in case the adhesive thickness is larger than 0.5 mm, it is not favorable to realize a narrow bezel of the liquid crystal display module. By controlling the thickness of adhesive, e.g. to a range of 0.05-0.1 mm, the bezel width of the liquid crystal display module is efficiently decreased, and the narrow bezel of the liquid crystal display module is realized. According to certain exemplary embodiments, in case the adhesive is used in place of the double-side adhesive tape, the bezel width of the liquid crystal display module is not restricted by the width of the double-side adhesive tape, but by factors such as a width of a peripheral non-display region of the liquid crystal display panel, and the thickness of adhesive. It is assumed that the peripheral non-display region has a width of 0.5 mm, in case the adhesive has a thickness of 0.05-0.1 mm, the bezel width of the liquid crystal display module is 0.55-0.6 mm, which is significantly smaller than a lower limit of 0.8 mm for the bezel width of the liquid crystal display module in which the double-side adhesive tape is used.

In an exemplary embodiment, the adhesive has a thickness of 0.1 mm.

According to certain exemplary embodiments of the present disclosure, the adhesive with a thickness of 0.1 mm provides sufficient strength of adhesion, so as to realize firm adhesion between the liquid crystal display panel and the backlight module. The thickness of adhesive is not limited a certain thickness, but selected in view of design requirements.

In a second aspect, an exemplary embodiment of the present disclosure provides a display device, which comprises the liquid crystal display module as described above.

In a third aspect, an exemplary embodiment of the present disclosure provides a method for fabricating a liquid crystal display module, comprising: applying an adhesive on an outer surface of at least a side of a liquid crystal display panel and a backlight module to be adhered; and curing the adhesive to fix the liquid crystal display panel and the backlight module to form the liquid crystal display module.

In an exemplary embodiment, prior to the step of applying adhesive, the method further comprises:

at a side of the liquid crystal display panel and the backlight module on which the adhesive is not applied, applying a double-side adhesive tape between the liquid crystal display panel and the backlight module.

In an exemplary embodiment, the liquid crystal display panel comprises an array substrate and a color film substrate, and the step of applying the double-side adhesive tape comprises: applying the double-side adhesive tape between the array substrate of the liquid crystal display panel and the backlight module.

In an exemplary embodiment, the step of applying the double-side adhesive tape comprises: at a side of the array substrate which extends beyond the color film substrate, applying the double-side adhesive tape between the array substrate and the backlight module.

In an exemplary embodiment, the adhesive is a UV curable adhesive, a thermosetting adhesive, or a thermoplastic adhesive.

In an exemplary embodiment, the adhesive is black in color.

In an exemplary embodiment, after curing, the adhesive has a thickness of 0.05-0.5 mm.

The method for fabricating the liquid crystal display module and the display device in exemplary embodiments of the present disclosure have same or similar beneficial effects as the liquid crystal display module as described above, which are not repeated here for simplicity.

According to certain exemplary embodiments of the present disclosure, the adhesive is applied on the outer surface of at least a side of the liquid crystal display panel and the backlight module, to replace the double-side adhesive tape which is applied between the liquid crystal display panel and the backlight module in the conventional liquid crystal display module. Thus, a novel solution for firmly adhering the liquid crystal display panel and the backlight module is provided. Besides, according to exemplary embodiments of the present disclosure, since the double-side adhesive tape is not used, the bezel width of the liquid crystal display module is not restricted by the width of the double-side adhesive tape, and by controlling the thickness of adhesive it is possible to decrease the bezel width of the liquid crystal display module.

In the context of the present disclosure, the “width” of the double-side adhesive tape refers to a size of the double-side adhesive tape in a plane of the liquid crystal display panel and in a direction perpendicular to an extending direction of the double-side adhesive tape. In the liquid crystal display module, the double-side adhesive tape is generally arranged on the surface of the liquid crystal display panel along the circumference of the liquid crystal display panel. Namely, the extending direction of the double-side adhesive tape is generally a direction which is parallel with a respective side of the liquid crystal display panel. Therefore, the “width” of the double-side adhesive tape also refers to a size of the double-side adhesive tape in the plane of the liquid crystal display panel, and in a direction perpendicular to each size of the liquid crystal display panel.

In the context of the present disclosure, the “thickness” of adhesive refers to a size of the adhesive in the plane of the liquid crystal display panel, and in a direction perpendicular to the outer surface of the side of the liquid crystal display panel or the backlight module. In the present disclosure, the adhesive is applied on an outer surface of at least a side of the liquid crystal display panel and the backlight module. Therefore, the “thickness” of the adhesive further refers to the size of the adhesive in the plane of the liquid crystal display panel, and in a direction perpendicular to respective side of the liquid crystal display panel.

In the context of the present disclosure, the “bezel width” of the liquid crystal display module refers to a distance from an outer side of an effective display region to an outer side of the liquid crystal display module or liquid crystal display panel, in a direction perpendicular to respective side, and in a plane of the liquid crystal display module or the liquid crystal display panel.

### BRIEF DESCRIPTION OF THE DRAWINGS

FIGS. 1a, 1b are cross-sectional views for illustrating an existing liquid crystal display module. FIG. 1a is a cross-sectional view along a direction which is perpendicular to a side of the liquid crystal display module, and FIG. 1b is an enlarged view of a dotted portion of FIG. 1a.

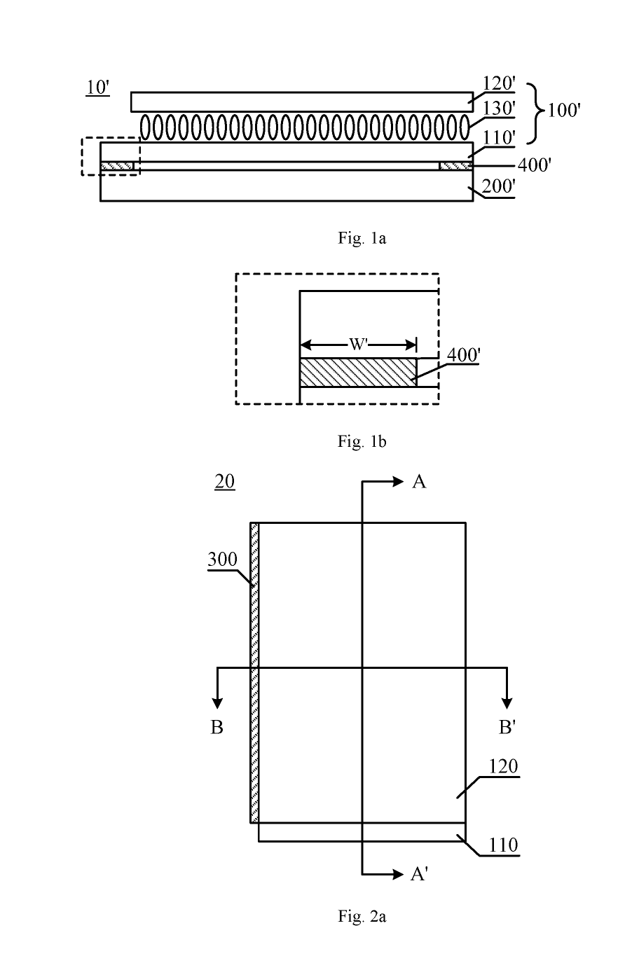

FIGS. 2a, 2b, 2c, 2d are diagrams for illustrating a liquid crystal display module in an exemplary embodiment of the present disclosure. FIG. 2a is a top view of the liquid crystal display module, and FIG. 2b is a cross-sectional view along line A-A′ of FIG. 2a, FIG. 2c is a cross-sectional view along line B-B′ of FIG. 2a, and FIG. 2d is an enlarged view of a dotted portion of FIG. 2c.

FIGS. 3a, 3b, 3c are diagrams for illustrating a liquid crystal display module in an exemplary embodiment of the present disclosure. FIG. 3a is a top view of a liquid crystal display module, FIG. 3b is a cross-sectional view along a line A-A′ in FIG. 3a, and FIG. 3c is a cross-sectional view along a line B-B′ in FIG. 3a.

FIGS. 4a, 4b, 4c are diagrams for illustrating a liquid crystal display module in an exemplary embodiment of the present disclosure. FIG. 4a is a top view of a liquid crystal display module, FIG. 4b is a cross-sectional view along a line A-A′ in FIG. 4a, and FIG. 4c is a cross-sectional view along a line B-B′ in FIG. 4a.

FIGS. 5a, 5b, 5c, 5d are diagrams for illustrating a liquid crystal display module in an exemplary embodiment of the present disclosure. FIG. 5a is a top view of a liquid crystal display module, FIG. 5b is a cross-sectional view along a line A-A′ in FIG. 5a, FIG. 5c is a cross-sectional view along a line B-B′ in FIG. 5a, and FIG. 5d is an enlarged view in a dotted portion of FIG. 5b.

FIG. 6 is a flow chart for illustrating a method for fabricating a liquid crystal display module in an exemplary embodiment of the present disclosure.

### DETAILED DESCRIPTION OF EMBODIMENTS

Specific embodiments of the present disclosure will be further described hereinafter with reference to the drawings and embodiments. The following embodiments are only used for explaining more clearly the technical solution of the present disclosure rather than limiting the protection scope of the present disclosure.

Reference numerals: 10′ liquid crystal display module; 100′ liquid crystal display panel; 110′ array substrate; 120′ color film substrate; 130′ liquid crystal; 200′ backlight module; 400′ double-side adhesive tape; W′ the width of the double-side adhesive tape; 20, 30, 40, 50 liquid crystal display module; 100 liquid crystal display panel; 110 array substrate; 120 color film substrate; 200 backlight module; 300 adhesive; T the thickness of adhesive; 400 double-side adhesive tape; W the width of the double-side adhesive tape.

According to exemplary embodiments of the present disclosure, a liquid crystal display module comprises a liquid crystal display panel and a backlight module. The liquid crystal display panel and the backlight module are fixed by an adhesive which is applied on an outer surface of at least a side. The liquid crystal display module of the present disclosure will be described hereinafter with reference to specific embodiments.

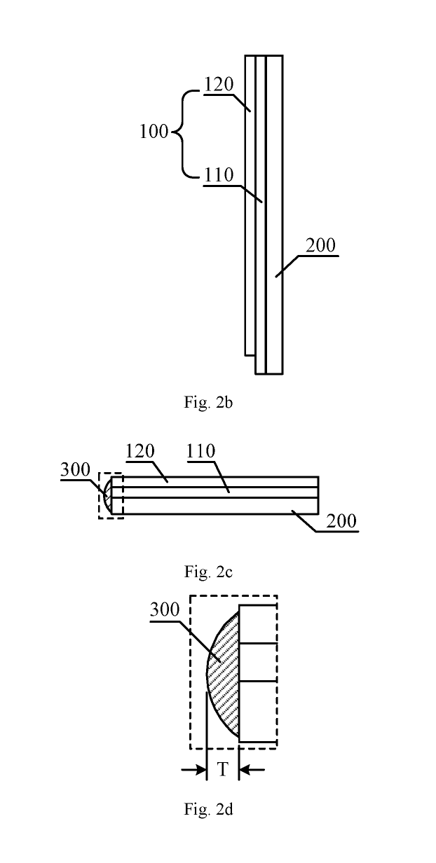

FIGS. 2a, 2b, 2c, 2d show a liquid crystal display module 20 in an exemplary embodiment of the present disclosure. FIG. 2a shows a top view of the liquid crystal display module 20, FIG. 2b shows a cross-sectional view along a line A-A′ (parallel with a pair of sides), FIG. 2c shows a cross-sectional view along a line B-B′ (parallel with the other pair of sides), and FIG. 2d shows an enlarged view in a dotted portion of FIG. 2c.

As shown in FIGS. 2b, 2c, the liquid crystal display module 20 comprises a backlight module 200 and a liquid crystal display panel 100 which is arranged on the backlight module 200. The liquid crystal display panel 100 comprises an array substrate 110, a color film substrate 120, and liquid crystal (not shown) which are arranged therebetween.

As shown in FIG. 2a, in the exemplary embodiment, the liquid crystal display module 20 adopts an adhesive 300, which is applied on an outer surface of only one side (for example, left side) of the liquid crystal display panel 100 and the backlight module 200.

As shown in the enlarged view in FIG. 2d, the adhesive 300 has a thickness T of 0.05-0.5 mm. The thickness T of the adhesive 300 is defined as a distance from the highest point of the cross section to the outer surface of a corresponding side of the liquid crystal display panel 100 and the backlight module 200. The adhesive 300 has an arch cross section shown in FIGS. 2c, 2d. However, this is schematic in nature. In other exemplary embodiments, the adhesive 300 has a trapezoid cross section, a truncated arch cross section, or the like.

In the exemplary embodiment, the adhesive 300 is only applied on an outer surface of the left side. In this case, when the adhesive 300 has an appropriate thickness T, e.g., when the thickness T is 0.1 mm, the adhesive 300 is capable of providing sufficient strength of adhesion, so that the liquid crystal display panel 100 and the backlight module 200 are firmly adhered.

In practice, the thickness T of the adhesive 300 is selected in view of design requirements. In one aspect, for purpose that the liquid crystal display module 20 has a narrow bezel, the thickness T of the adhesive 300 is set in a range of 0.05-0.1 mm, to efficiently decrease the bezel width of the liquid crystal display module 20. In this case, when the liquid crystal display module 20 has a non-display region with a width of 0.5 mm, the bezel width of the liquid crystal display module 20 is 0.55-0.6 mm. Therefore, the liquid crystal display module 20 only has a bezel width of 0.55-0.6 mm at the left side, which is significantly smaller than the lower limit of 0.8 mm for the bezel width when the double-side adhesive tape is adopted. Namely, by applying the adhesive 300 on the outer surface of a side, it is possible to decrease the bezel width of the liquid crystal display module 20 at this side. In another aspect, the adhesive 300 may have a relatively large thickness T, e.g., 0.1-0.5 mm, so as to further increase the strength of adhesion between the liquid crystal display panel 100 and the backlight module 200.

The adhesive 300 can be a UV curable adhesive, a thermosetting adhesive, or a thermoplastic adhesive. Therefore, any UV curable adhesive, thermosetting adhesive or thermoplastic adhesive which is common in the art can be adopted for fixing the liquid crystal display panel 100 and the backlight module 200.

The adhesive 300 is black in color adhesive. The black adhesive 300 is opaque, so that is prevents light leakage in the liquid crystal display module 20. Of course, the adhesive 300 can be other colors.

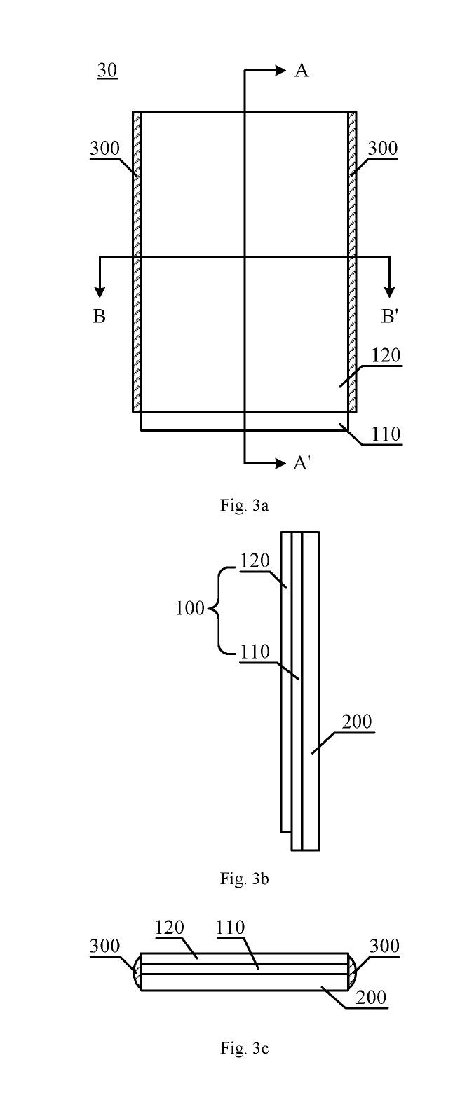

FIGS. 3a, 3b, 3c show a liquid crystal display module 30 in an exemplary embodiment of the present disclosure. FIG. 3a shows a top view of the liquid crystal display module 30, FIG. 3b shows a cross-sectional view along a line A-A′ in FIG. 3a, and FIG. 3c shows a cross-sectional view along a line B-B′ in FIG. 3a.

The liquid crystal display module 30 of the exemplary embodiment differs from the liquid crystal display module 20 in the previous embodiment in the following aspects. The adhesive 300 is applied on the outer surface of two sides of the liquid crystal display panel 100 and the backlight module 200. As shown in FIGS. 3a, 3c, the adhesive 300 is applied on the outer surface of left and right sides of the liquid crystal display panel 100 and the backlight module 200. In the exemplary embodiment, the adhesive 300 is applied on the outer surface of a pair of opposite sides of the liquid crystal display panel 100 and the backlight module 200. Of course, the adhesive 300 can also be applied on the outer surface of the pair of neighboring sides of the liquid crystal display panel 100 and the backlight module 200.

Other aspects of the liquid crystal display module 30 are similar to those of the liquid crystal display module 20, which are not repeated here for simplicity.

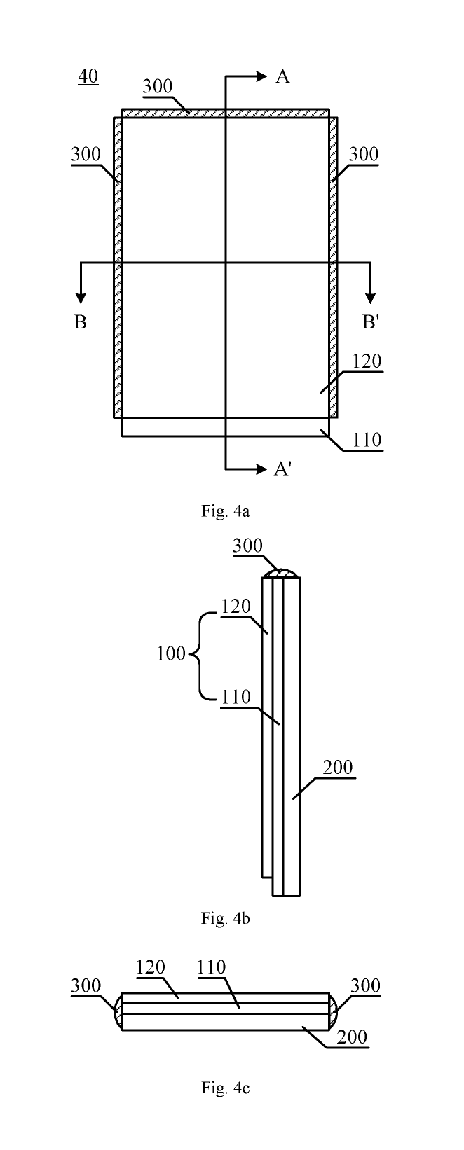

FIGS. 4a, 4b, 4c show a liquid crystal display module 40 in an exemplary embodiment of the present disclosure. FIG. 4a shows a top view of the liquid crystal display module 40, FIG. 4b shows a cross-sectional view along a line A-A′ in FIG. 4a, and FIG. 4c shows a cross-sectional view along a line B-B′ in FIG. 4a.

The the liquid crystal display module 40 of the exemplary embodiment differs from the liquid crystal display modules 20, 30 in the previous embodiments in the following aspects. The adhesive 300 is applied on the outer surface of three sides of the liquid crystal display panel 100 and the backlight module 200. As shown in FIGS. 4a, 4c, the adhesive 300 is applied on the outer surface of the left, upper, and right sides of the liquid crystal display panel 100 and the backlight module 200.

Other aspects of the liquid crystal display module 40 are similar to those of the liquid crystal display modules 20, 30, which are not repeated here for simplicity.

It is noted that on the basis of the exemplary embodiment shown in FIGS. 4a, 4b, 4c, the liquid crystal display module can further comprise the adhesive 300 which is applied on the outer surface of the lower side of the liquid crystal display panel 100 and the backlight module 200. Namely, the liquid crystal display module comprises the adhesive which is applied on the outer surface of four sides of the liquid crystal display panel and the backlight module.

Therefore, the adhesive is applied at a corresponding side(s) of the liquid crystal display panel and the backlight module in view of design requirements, so as to realize firm adhesion between the liquid crystal display panel and the backlight module. Besides, by controlling the thickness of adhesive, it is possible to decrease the bezel width of the liquid crystal display module at the corresponding side(s).

It is noted that, in the liquid crystal display module of the present disclosure, it is also possible to apply the double-side adhesive tape at a side of the liquid crystal display panel and the backlight module on which the adhesive is not applied. In particular, at a side of the liquid crystal display panel and the backlight module on which the adhesive is not applied, the double-side adhesive tape is applied between the liquid crystal display panel and the backlight module.

For example, in FIG. 2a, the double-side adhesive tape can be applied at one or more of the upper, lower, and right sides of the liquid crystal display module 20. In FIG. 3a, the double-side adhesive tape can be applied at one or both of the upper and lower sides of the liquid crystal display module 30. In FIG. 4a, the double-side adhesive tape can be applied at the lower side of the liquid crystal display module 40. The combination of the adhesive and the double-side adhesive tape further increases the strength of adhesion between the liquid crystal display panel 100 and the backlight module 200.

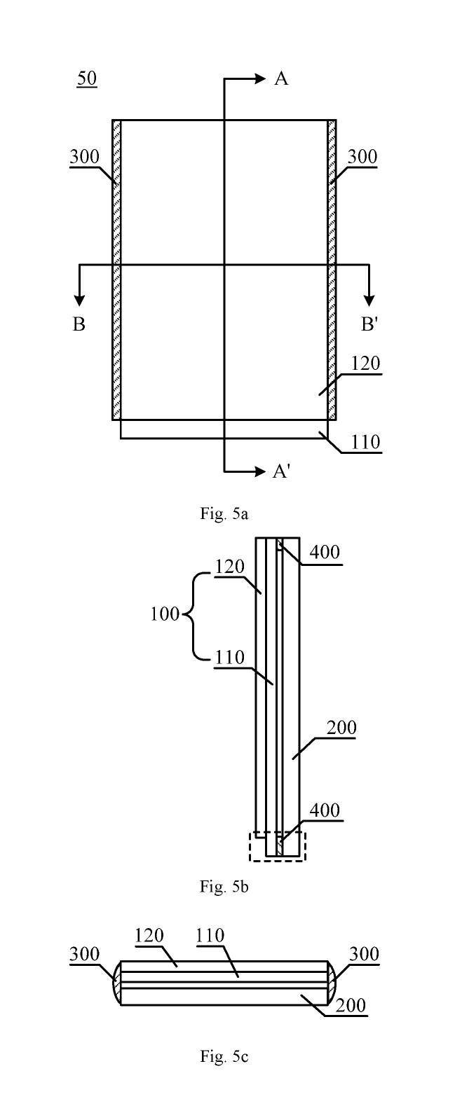

FIGS. 5a, 5b, 5c, 5d show a liquid crystal display module 50 in an exemplary embodiment of the present disclosure. FIG. 5a shows a top view of the liquid crystal display module 50, FIG. 5b shows a cross-sectional view along a line A-A′ in FIG. 5a, FIG. 5c shows a cross-sectional view along a line B-B′ in FIG. 5a, and FIG. 5d shows an enlarged view in a dotted portion of FIG. 5b.

The liquid crystal display module 50 comprises the backlight module 200 and the liquid crystal display panel 100 which is arranged on the backlight module 200. The liquid crystal display panel 100 comprises the array substrate 110 and the color film substrate 120. As shown in FIG. 5a, in the liquid crystal display module 50 of the exemplary embodiment, the adhesive 300 is applied on the outer surface of a pair of opposite sides (i.e., left and right sides) of the liquid crystal display panel 100 and the backlight module 200.

As shown in the lower side of FIGS. 5a, 5b, in a direction parallel with the line A-A′, the array substrate 110 has a width larger than that of the color film substrate 120. Namely, the array substrate 110 extends beyond the color film substrate 120 at the lower side. Generally, at the lower side, a peripheral region of the array substrate 110 by which the array substrate 110 is wider than the color film substrate 120 acts as, e.g., a FPC connection region or a driver IC bonding region. Since the FPC or driver IC chip is generally opaque, the bezel width at the lower side of liquid crystal display module 50 is not sensitive to whether the double-side adhesive tape is used or the width of the double-side adhesive tape, but sensitive to the FPC connection region or the driver IC bonding region. Therefore, as shown in FIGS. 5b and 5d, the double-side adhesive tape 400 is applied between the array substrate 110 and the backlight module 200 at the lower side, to further increase the strength of adhesion. The double-side adhesive tape 400 has at width W, and there is no special restriction to the width.

In an exemplary embodiment, the double-side adhesive tape 400 is further applied between the array substrate 110 and the backlight module 200 at the upper side, as shown in the top portion of FIG. 5b. In this case, the double-side adhesive tape 400 generally has a small width at the upper side, e.g., 0.8 mm, so as to a large bezel width at the upper side. In contrast to this, as described above, the double-side adhesive tape 400 can have a relatively large width W at the lower side.

It is noted that FIGS. 5a, 5b, 5c only schematically show examples of the FPC connection region or driver IC bonding region. For example, the FPC connection region or driver IC bonding region can further be arranged at two neighboring sides of the liquid crystal display module 50.

An exemplary embodiment of the present disclosure further provides a display device, which comprise any one of the liquid crystal display module 20, 30, 40, 50 as described above.

The display device can be any product or component with a display function like a mobile phone, tablet computer, TV, monitor, notebook computer, digital photo frame, and navigator. The display device may further comprise other components known for the ordinary skilled person in the art, which are not repeated here for simplicity and are not construed as restrictions of the present disclosure. As for embodiments of the display device, reference can be made to the above embodiments of the liquid crystal display modules 20, 30, 40, 50, which are not repeated here for simplicity.

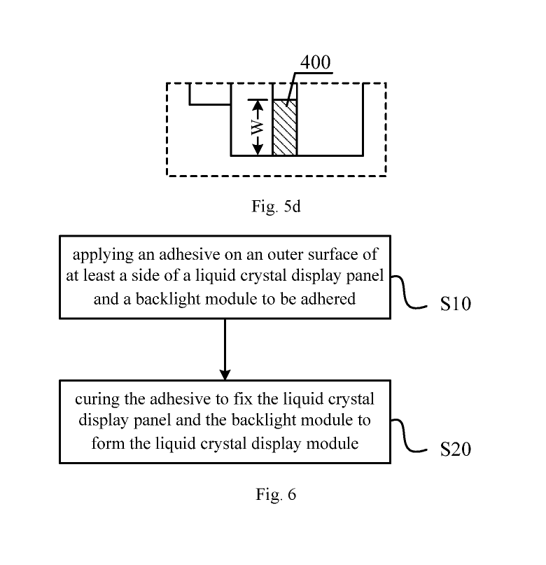

The present disclosure further provides a method for fabricating the liquid crystal display module. As shown in the flow chart of FIG. 6, the method comprises: step S10, applying an adhesive on an outer surface of at least a side of a liquid crystal display panel and a backlight module to be adhered; and step S20, cure adhesive, so as to fix the liquid crystal display panel and the backlight module to form liquid crystal display module.

In an exemplary embodiment of the method, prior to step S10, the method further comprises: step S110, at a side of the liquid crystal display panel and the backlight module on which the adhesive is not applied, applying a double-side adhesive tape between the liquid crystal display panel and the backlight module.

In an exemplary embodiment of the method, the liquid crystal display panel comprises an array substrate and a color film substrate, and step S110 comprises: applying the double-side adhesive tape between the array substrate of the liquid crystal display panel and the backlight module.

In an exemplary embodiment of the method, step S110 comprises: on a side of the array substrate which extends beyond the color film substrate, applying the double-side adhesive tape between the array substrate and the backlight module.

In an exemplary embodiment of the method, the adhesive is a UV curable adhesive, a thermosetting adhesive, or a thermoplastic adhesive.

In an exemplary embodiment of the method, for example, the adhesive is black in color.

In an exemplary embodiment of the method, for example, after curing, the adhesive has a thickness of 0.05-0.5 mm.

It is noted that conventional methods and apparatuses can be adopted to perform steps or acts in the above method, e.g., applying and curing the adhesive, applying the double-side adhesive tape. For sake of simplicity, description of the conventional method and apparatus is omitted in the present disclosure.

According to certain exemplary embodiments of the present disclosure, in the liquid crystal display module, the adhesive is applied on the outer surface of at least a side of the liquid crystal display panel and the backlight module, to realize firm adhesion therebetween. Since the adhesive is applied on the outer surface of the side to fix the liquid crystal display panel and the backlight module, the double-side adhesive tape is no longer required for adhesion. Namely, exemplary embodiments of the present disclosure provide a solution for replacing the double-side adhesive tape, and the solution realizes firm adhesion between the liquid crystal display panel and the backlight module. In addition, according to exemplary embodiments of the present disclosure, since the double-side adhesive tape is not used, the bezel width of the liquid crystal display module is not restricted by the width of the double-side adhesive tape, and by controlling the thickness of adhesive, it is possible to decrease the bezel width of the liquid crystal display module.

Apparently, the person with ordinary skill in the art can make various modifications and variations to the present disclosure without departing from the spirit and the scope of the present disclosure. In this way, provided that these modifications and variations of the present disclosure belong to the scopes of the claims of the present disclosure and the equivalent technologies thereof, the present disclosure also intends to encompass these modifications and variations.

1. A liquid crystal display module comprising: a liquid crystal display panel and a backlight module, wherein the liquid crystal display panel and the backlight module are fixed by an adhesive applied on an outer surface of at least one side.

2. The liquid crystal display module of claim 1, wherein the adhesive is applied on the outer surface of four sides of the liquid crystal display panel and the backlight module.

3. The liquid crystal display module of claim 1, wherein the adhesive is applied on the outer surface of one side, two sides, or three sides of the liquid crystal display panel and the backlight module.

4. The liquid crystal display module of claim 3, wherein at a side of the liquid crystal display panel and the backlight module on which the adhesive is not applied, the double-side adhesive tape is applied between the liquid crystal display panel and the backlight module.

5. The liquid crystal display module of claim 4, wherein the liquid crystal display panel comprises an array substrate and a color film substrate, and the liquid crystal display panel is fixed to the backlight module through the array substrate; and
at a side of the array substrate of the liquid crystal display panel which extends beyond the color film substrate, the double-side adhesive tape is applied between the array substrate and the backlight module.

6. The liquid crystal display module of claim 1, wherein the adhesive is a UV curable adhesive, a thermosetting adhesive, or a thermoplastic adhesive.

7. The liquid crystal display module of claim 1, wherein the adhesive is black in color.

8. The liquid crystal display module of claim 1, wherein the adhesive has a thickness of 0.05-0.5 mm.

9. A display device, comprising the liquid crystal display module of claim 1.

10. A method for fabricating a liquid crystal display module, comprising:
step S10, applying an adhesive on an outer surface of at least a side of a liquid crystal display panel and a backlight module to be adhered; and
step S20, curing the adhesive to fix the liquid crystal display panel and the backlight module to form the liquid crystal display module.

11. The method of claim 10, wherein prior to the step of applying adhesive, the method further comprises:
at a side of the liquid crystal display panel and the backlight module on which the adhesive is not applied, applying a double-side adhesive tape between the liquid crystal display panel and the backlight module.

12. The method of claim 11, wherein the liquid crystal display panel comprises an array substrate and a color film substrate, and the step of applying the double-side adhesive tape comprises:
applying the double-side adhesive tape between the array substrate of the liquid crystal display panel and the backlight module.

13. The method of claim 12, wherein the step of applying the double-side adhesive tape comprises:
at a side of the array substrate which extends beyond the color film substrate, applying the double-side adhesive tape between the array substrate and the backlight module.
